(19) United States
(12) Patent Application Publication
(10) Pub. No.: US 2022/0208003 A1
(43) Pub. Date: Jun. 30, 2022

(54) MOBILE BODY AND CONTROL METHOD FOR MOBILE BODY

(71) Applicant: Mitsubishi Electric Corporation, Tokyo (JP)

(72) Inventors: Masataka SHIROZONO, Tokyo (JP); Takashi MATSUMOTO, Tokyo (JP); Takahisa AOYAGI, Tokyo (JP); Kenta KATSU, Tokyo (JP); Hiroshi YAMADA, Tokyo (JP)

(73) Assignee: Mitsubishi Electric Corporation, Tokyo (JP)

(21) Appl. No.: 17/604,693

(22) PCT Filed: Sep. 9, 2019
(86) PCT No.: PCT/JP2019/035299

§ 371 Date: Oct. 18, 2021

(51) Int. Cl. G08G 1/14

(52) U.S. Cl. CPC G08G 1/146; G08G 1/141; G08G 1/148

(57) ABSTRACT

A mobile body such that a parking lot management center specifies a parking place for the mobile body and the mobile body moves to the specified parking place, wherein the mobile body includes an automatic valet parking management device that, when the mobile body moves to the parking place but the mobile body cannot park in the parking place, requests a new parking place for the mobile body from the parking lot management center.

### TECHNICAL FIELD

The present application relates to a mobile body and a mobile body control method.

### BACKGROUND ART

An automatic valet parking system such that a mobile body is caused to automatically travel to an allocated parking place and caused to park automatically, rather than a user driving the mobile body, is receiving attention as an application of automatic driving of a mobile body such as a vehicle, as disclosed in, for example, Patent Literature 1. This kind of automatic valet parking system is such that a mobile body compatible with automatic valet parking in a parking lot as a whole is moved to an empty parking place in the parking lot by being caused to automatically travel, and caused to park, while communicating with a managing parking lot management center, or completely autonomously without depending on information from an external device.

### CITATION LIST

### Patent Literature

Patent Literature 1: JP-A-2018-97536

### SUMMARY OF INVENTION

### Technical Problem

However, the kind of automatic valet parking system disclosed in Patent Literature 1 is such that when there is already a parked mobile body in a parking place allocated by the parking lot management center, or when a parking position of a mobile body parked in a neighboring parking place encroaches on the allocated parking place and the allocated parking place is not a parking space that can accommodate the original mobile body, or the like, there is a problem in that the original mobile body cannot be parked.

The present application discloses technology for resolving the aforementioned kind of problem, and has an object of providing a mobile body and a mobile body control method such that a mobile body can be caused to park even when there is already a parked mobile body in a parking place allocated by a parking lot management center, or when the allocated parking place is not a parking space that can accommodate the original mobile body.

### Solution to Problem

A mobile body disclosed in the present application is a mobile body such that a parking lot management center specifies a parking place for the mobile body and the mobile body moves to the specified parking place, wherein the mobile body includes an automatic valet parking management device that, when the mobile body moves to the parking place but the mobile body cannot park in the parking place, requests a new parking place for the mobile body from the parking lot management center.

### Advantageous Effects of Invention

The mobile body disclosed in the present application is such that when there is already a parked mobile body in an allocated parking place, or when the allocated parking place is not a parking space that can accommodate the mobile body, parking can be carried out in a new parking place by issuing a new request for a parking place.

### BRIEF DESCRIPTION OF DRAWINGS

FIG. 1 is a top view showing a configuration of an automatic valet parking lot according to a first embodiment.

FIG. 2 is a drawing showing a configuration of an automatic valet parking system according to the first embodiment.

FIG. 3 is a flowchart showing operations of an automatic valet parking control process executed when an automatic valet parking mobile body according to the first embodiment enters.

FIG. 4 is a top view showing a case in which another parked mobile body already exists in a target parking place.

FIG. 5 is a top view showing a case in which another parked mobile body is parked encroaching on the target parking place.

FIG. 6 is a drawing showing one example of a hardware configuration realizing an automatic valet parking management device according to the first embodiment.

FIG. 7 is a drawing showing another example of a hardware configuration realizing the automatic valet parking management device according to the first embodiment.

### DESCRIPTION OF EMBODIMENTS

Hereafter, a preferred embodiment of a mobile body and a mobile body control method according to the present application will be described, using the drawings.

### First Embodiment

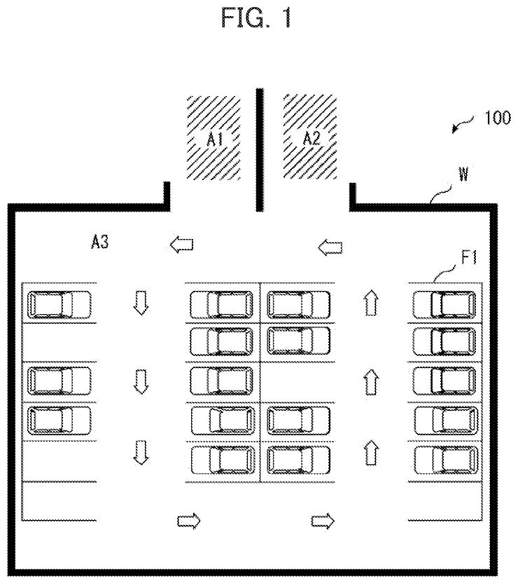

FIG. 1 is a top view showing a configuration of an automatic valet parking lot, that is, a parking lot wherein a mobile body can be caused to automatically travel to an allocated parking place and caused to park automatically, rather than a user driving the mobile body, according to a first embodiment. An automatic valet parking lot 100 is divided into a wall W, a disembarkation area A1, an embarkation area A2, and a parking area A3.

When entering the automatic valet parking lot 100, a user of a mobile body (hereafter called a vehicle) compatible with automatic valet parking disembarks in the disembarkation area A1, after which the vehicle is caused to move from the disembarkation area A1 to a parking place in the parking area A3 by automatic travel, and caused to park automatically. Also, when departing, the vehicle is caused to move from the parking place in the parking area A3 to the embarkation area A2 by automatic travel, after which the user of the vehicle embarks in the embarkation area A2.

The parking area A3 includes a path along which the vehicle passes when entering or departing, and a multiple of parking places, each of which is enclosed by a rectangular parking frame F1 that is slightly larger than an upper face external form of the vehicle. White arrows shown in FIG. 1 indicate a direction of one-way traffic on the path in the parking area A3.

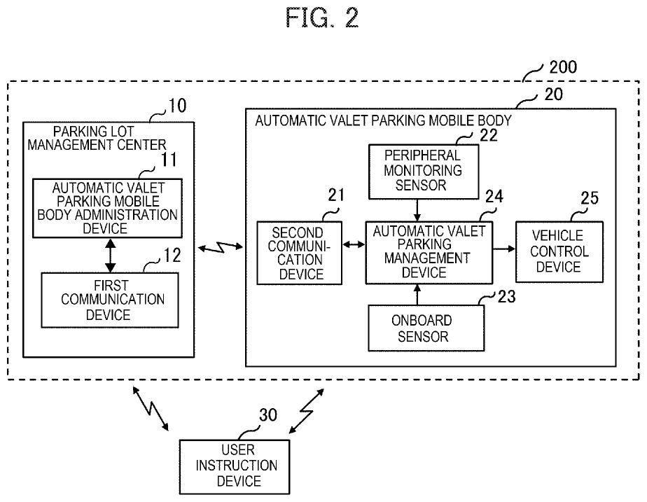

FIG. 2 is a drawing showing a configuration of an automatic valet parking system. An automatic valet parking system 200 shown in FIG. 2 includes a parking lot management center 10 and a vehicle 20, and automatic valet parking in the heretofore described automatic valet parking lot 100 is carried out using this system.

The parking lot management center 10 includes an automatic valet parking mobile body administration device 11 and a first communication device 12. The automatic valet parking mobile body administration device 11 manages parking lot information, parking space information, and guidance route information.

Information such as an overall form of the automatic valet parking lot 100, a position and a size of a parking space, a position of the parking frame F1 or the wall W, and a width of a vehicle road is included in the parking lot information. Parking position data (for example, coordinate information relating to a central position of a parking place) indicated by the parking lot information, full parking place information, and empty parking place information are included in the parking place information. Guidance route information (for example, coordinate information as far as a target parking place) indicating a movement route from the vehicle 20 starting automatic travel until automatically parking in a target parking place is included in the guidance route information.

The automatic valet parking mobile body administration device 11, in response to an entry request signal, selects an empty parking place for the vehicle 20 (a target parking place the vehicle 20 should head for), and compiles guidance route information from the disembarkation area A1 to the relevant parking place for the vehicle 20 for which entry has been requested. Also, in response to a departure request signal, the automatic valet parking mobile body administration device 11 compiles guidance route information from the parking place to the embarkation area A2 for the vehicle 20 for which departure has been requested. Furthermore, in response to a new empty parking place request signal, the automatic valet parking mobile body administration device 11 compiles a new target parking place and guidance route information for the vehicle 20.

The first communication device 12 receives each of an entry request signal requesting entry and a departure request signal requesting departure. An entry request signal is transmitted from a user instruction device 30 possessed by a user who wishes to cause the vehicle 20 to be entered in the parking area A3 of the automatic valet parking lot 100. Also, a departure request signal is transmitted from the user instruction device 30 possessed by a user who wishes to cause the vehicle 20 to depart from the parking area A3 of the automatic valet parking lot 100.

The first communication device 12 transmits parking lot information, a target parking place, and guidance route information obtained from the automatic valet parking mobile body administration device 11 to the vehicle 20 for which entry has been requested by an entry request signal transmitted from the user instruction device 30, and transmits parking lot information and guidance route information obtained from the automatic valet parking mobile body administration device 11 to the vehicle 20 for which departure has been requested by a departure request signal transmitted from the user instruction device 30. Also, the first communication device 12 transmits a new target parking place and guidance route information to the vehicle 20 in response to a new empty parking place request signal, as will be described hereafter.

A portable electronic instrument (for example, a smartphone, a tablet, or a mobile telephone) carried by a user, or a keyless entry system of the vehicle 20, can be used as the user instruction device 30. An entry reception terminal may be installed in the disembarkation area A1, and the entry reception terminal may be used instead of the user instruction device 30 that transmits an entry request signal. In the same way, a departure reception terminal may be installed in the embarkation area A2, and the departure reception terminal may be used instead of the user instruction device 30 that transmits a departure request signal.

The vehicle 20 includes a second communication device 21, a peripheral monitoring sensor 22, an onboard sensor 23, an automatic valet parking management device 24, and a vehicle control device 25.

The second communication device 21 acquires information transmitted from the first communication device 12, and transmits a new empty parking place request signal from the automatic valet parking management device 24 to the first communication device 12.

The peripheral monitoring sensor 22 monitors a situation in the vehicle periphery based on a result of a measurement by an unshown distance sensor, for example, any one or a multiple of an image sensor that films the periphery of the vehicle, a millimeter-wave radar, a laser radar, or an ultrasonic sensor.

The onboard sensor 23 acquires host vehicle information. The host vehicle information is, for example, a steering angle sensor, a steering torque sensor, a yaw rate sensor, a speed sensor, an acceleration sensor, and a global navigation satellite system (hereafter called a GNSS).

The automatic valet parking management device 24 causes the vehicle 20 to travel automatically along an entry guidance route based on entry guidance route information acquired by the second communication device 21, and causes the vehicle 20 to automatically park. Also, the automatic valet parking management device 24 causes the vehicle 20 to travel automatically along a departure guidance route based on departure guidance route information acquired by the second communication device 21.

When an obstacle in the periphery of the vehicle 20 is detected by the peripheral monitoring sensor 22, the automatic valet parking management device 24 autonomously executes collision avoidance driving for avoiding a collision between the obstacle and the vehicle 20. Also, the automatic valet parking management device 24 detects a parking space while the vehicle 20 is automatically traveling to a parking place, or until automatic parking is started, in order to determine, based on a result of a measurement by any one or a multiple of the aforementioned kinds of sensor, whether an allocated parking place is actually empty (whether there is no vehicle there), or whether the allocated parking place is a parking space that can accommodate the vehicle.

A method of detecting using a result of a measurement by an ultrasonic sensor is disclosed in, for example, JP-A-2016-101770 as a method of detecting a parking space, but the parking space detection method is not particularly limited. As information relating to parking space detection, there is a parking place width, a parking place size, or a parking place depth.

The automatic valet parking management device 24 determines whether or not the vehicle can park in a parking place using the aforementioned parking place width, parking place size, or parking place depth. Also, the automatic valet parking management device 24 calculates a current position using host vehicle information from the aforementioned onboard sensor 23.

When determining that the vehicle cannot be caused to park in a parking place, the automatic valet parking management device 24 transmits a new empty parking place request signal to the automatic valet parking mobile body administration device 11 via the second communication device 21 and the first communication device 12, and issues a new empty parking place request.

The automatic valet parking management device 24 outputs a command to the vehicle control device 25 to cause the vehicle 20 to travel automatically along an entry guidance route based on a parking place and entry guidance route information newly acquired by the second communication device 21, and to automatically park. The vehicle control device 25 carries out controls such as a drive control that controls an accelerator and a brake of the vehicle 20 and a steering control that controls steering in accordance with the command output from the automatic valet parking management device 24, thereby causing the vehicle 20 to park in a parking place.

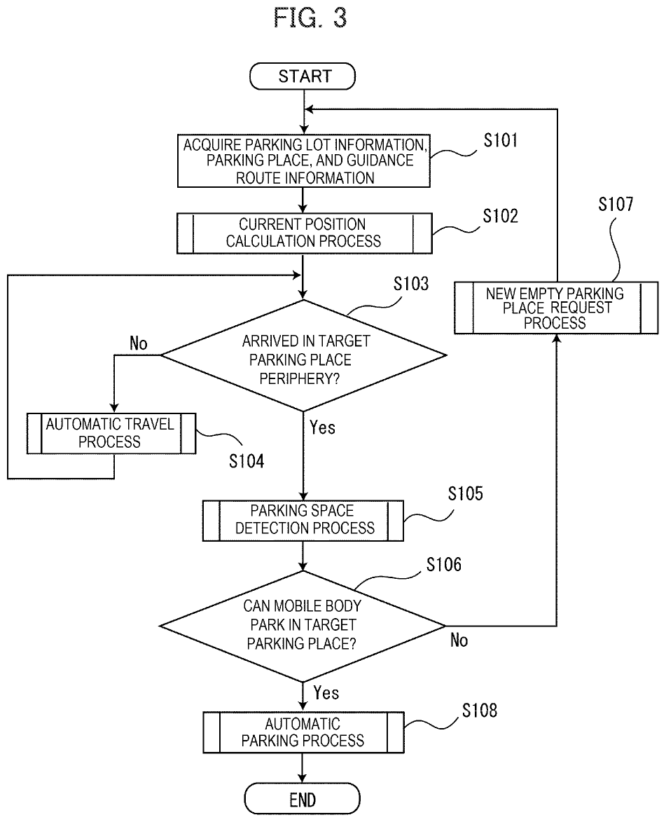

Next, an automatic valet parking control process executed when the vehicle 20 enters will be described, with reference to FIG. 3. FIG. 3 is a flowchart showing operations of the automatic valet parking control process executed when the vehicle 20 enters. The automatic valet parking control process is executed when the first communication device 12 receives an entry request signal.

When the automatic valet parking control process is executed, firstly, the automatic valet parking management device 24 of the vehicle 20 acquires parking lot information, a parking place, and guidance route information from the parking lot management center 10 via the second communication device 21 (step S101).

Next, a process of calculating a current position of the vehicle 20 is executed by the automatic valet parking management device 24 in step S102. The current position calculation process executed in step S102 is such that a current position obtained from positional information received from a GNSS is calculated when a situation is such that positional information from the GNSS can be received and positioning accuracy is good, a current position obtained from information obtained by an image sensor of the peripheral monitoring sensor 22 that films the periphery of the vehicle recognizing a singularity, a marker, or a landmark installed in the parking lot 100 is calculated when a situation is such that positional information from the GNSS can be received but positioning accuracy is poor or cannot be received, and when the aforementioned information can still not be acquired, a hypothetical current position of the vehicle 20 obtained by dead reckoning is calculated.

Further, the vehicle control device 25 causes the vehicle 20 to head toward a target parking place by automatic travel based on a result of the calculation by the automatic valet parking management device 24, together with the parking lot information, the parking place, and the guidance route information.

In a process of step S103, it is determined whether or not the vehicle 20 has arrived at a point immediately before the target parking place, and when it is determined that the vehicle 20 has not arrived in a periphery of the target parking place, a process of automatic travel toward the target parking place is executed in step S104, and the process of step S103 is returned to.

The automatic travel process executed in step S104 is a process of outputting an instruction to the vehicle control device 25 in order that the vehicle 20 moves by automatic travel along the route indicated by the guidance route information. Further, the processes of step S103 and S104 are repeatedly executed, and the automatic travel of the vehicle 20 is continued, until the vehicle 20 arrives at a point immediately before the target parking place.

Next, a parking space detecting process is executed in step S105. The parking space detecting process executed in step S105 is a process of detecting a parking space in order to determine whether the aforementioned allocated parking place is actually empty (whether there is no vehicle there), or whether the allocated parking place is a parking space that can accommodate the vehicle.

In step S106, the automatic valet parking management device 24 determines whether or not there is an empty parking place based on a parking place width, a parking place size, or a parking place depth obtained in step S105. For example, when the width of a detected parking place is 0.7 m or more greater than a width of the vehicle, the automatic valet parking management device 24 recognizes that the detected parking place is an empty parking place. When there is an empty parking place, a shift is made to an automatic parking process of step S108, to be described hereafter. When there is no empty parking place, the automatic valet parking management device 24 determines that parking cannot be carried out, and shifts to a new empty parking place request process of step S107.

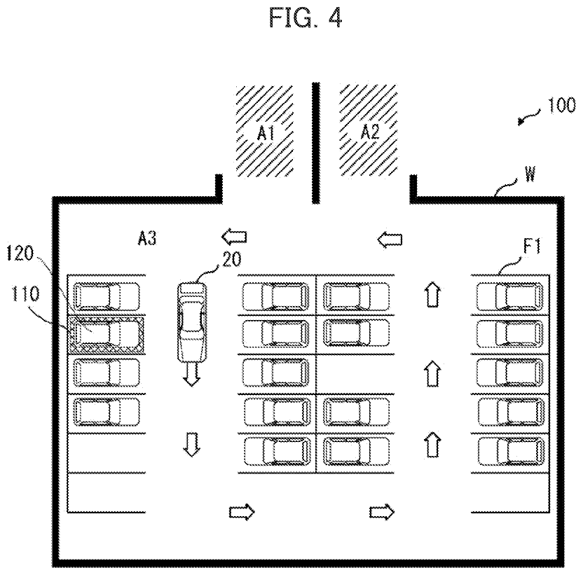

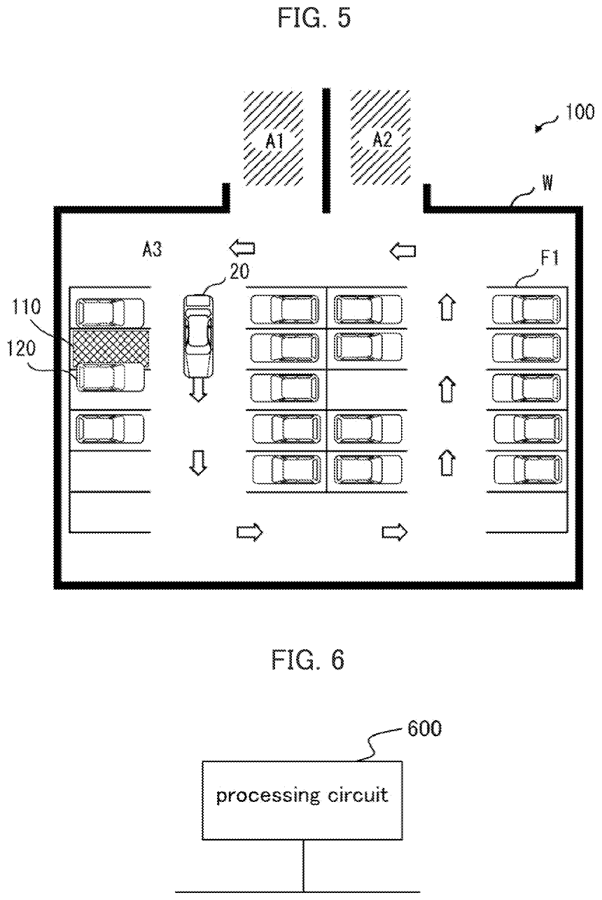

It can be determined by the process of step S106 that parking cannot be carried out when another vehicle 120 already exists in a target parking place 110, as shown in FIG. 4, when the target parking place is not a parking space that can accommodate the vehicle 20 due to the other vehicle 120 being parked encroaching on the target parking place, as shown in FIG. 5, or the like.

The new empty parking place request process executed in step S107 is a process of the automatic valet parking management device 24 transmitting a new empty parking place request signal to the automatic valet parking mobile body administration device 11 via the second communication device 21 and the first communication device 12. When the new empty parking place request process ends, new empty parking place information can be acquired from the parking lot management center 10 by shifting to step S101, and parking in a new empty parking place can be carried out.

Methods of realizing the automatic parking process executed in step S108 have already been proposed, and utilize technology disclosed in, for example, JP-A-2017-88112 or Japanese Patent No. 6,124,977. In the present embodiment, the automatic parking process is realized using these existing automatic parking process methods.

Each device according to the present embodiment can be configured using a computer, and is realized by the computer executing a program. That is, the automatic valet parking management device 24 is realized by, for example, a processing circuit 600 shown in FIG. 6. A processor such as a CPU or a DSP (digital signal processor) is applied as the processing circuit 600, and a function of each unit is realized by a program stored in a storage device being executed.

Dedicated hardware may be applied as the processing circuit 600. When the processing circuit 600 is dedicated hardware, for example, a single circuit, a composite circuit, a programmed processor, a parallel-programmed processor, an ASIC, an FPGA, or a combination of these, is applicable as the processing circuit 600.

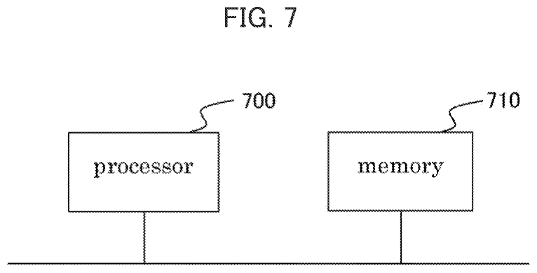

Also, FIG. 7 shows a hardware configuration when the automatic valet parking management device 24 is configured using a processor. In this case, each process by the automatic valet parking management device 24 is realized by a combination with software or the like (software, firmware, or software and firmware). The software or the like is described as a program, and is stored in a memory 710. A processor 700 that functions as a processing circuit realizes the function of each unit by reading and executing a program stored in the memory (storage device) 710.

According to an embodiment of the present application, as heretofore described, a vehicle can be caused to park even when there is already a parked vehicle in a parking place allocated by a parking lot management center, when a parking position of a vehicle parked in a neighboring parking place encroaches on the allocated parking place and the allocated parking place is not a parking space that can accommodate the vehicle, or the like.

Although the present application is described above in terms of an exemplifying embodiment, it should be understood that the various features, aspects, and functions described in the embodiment are not limited in their applicability to the particular embodiment with which they are described, but instead can be applied, alone or in various combinations, to the embodiment.

It is therefore understood that numerous modifications which have not been exemplified can be devised without departing from the scope of the present application. For example, at least one constituent component may be modified, added, or eliminated.

### REFERENCE SIGNS LIST

10 parking lot management center, 11 automatic valet parking mobile body administration device, 12 first communication device, 20 automatic valet parking mobile body (vehicle), second communication device, 22 peripheral monitoring sensor, 23 onboard sensor, 24 automatic valet parking management device, 25 vehicle control device, 30 user instruction device, 100 automatic valet parking lot, 110 target parking place, 120 other vehicle, 600 processing circuit, 700 processor, 710 memory, W wall, A1 disembarkation area, A2 embarkation area, A3 parking area, F1 parking frame.

1. A mobile body such that a parking lot management center specifies a parking place for the mobile body and the mobile body moves to the specified parking place, the mobile body comprising
an automatic valet parking management device that, when the mobile body moves to the parking place but the mobile body cannot park in the parking place, requests a new parking place for the mobile body from the parking lot management center.

2. The mobile body according to claim 1, wherein the mobile body comprises a vehicle control device, and the vehicle control device causes the mobile body to move to a new parking place based on new specification information obtained by the automatic valet parking management device from the parking lot management center based on the new request.

3. A mobile body control method such that a parking lot management center specifies a parking place for a mobile body and causes the mobile body to move to the specified parking place, wherein,
when the mobile body is caused to move to the specified parking place but the mobile body cannot park in the parking place, a new parking place for the mobile body is caused to be requested from the parking lot management center by the mobile body.

4. The mobile body control method according to claim 3, wherein the mobile body is caused to move to a new parking place based on new specification information obtained from the parking lot management center based on the new request.
